(19) United States
(12) Patent Application Publication
(10) Pub. No.: US 2005/0083808 A1
(43) Pub. Date: Apr. 21, 2005

(54) Audio player with CD mechanism

(76) Inventors: Hans Carl Anderson, Bloomington, MN (US); Reginald L. McNutt, Plymouth, MN (US)

Correspondence Address: Schwegman, Lundberg, Woessner & Kluth, P.A., P.O. Box 2938, Minneapolis, MN, 55402, US

(21) Appl. No.: 10/943,801

(22) Filed: Sep. 17, 2004

Related U.S. Application Data
(60) Provisional application No. 60/504,164, filed on Sep. 18, 2003.

(51) Int. Cl. G11B 5/09

(52) U.S. Cl. 369/47.28; 369/47.35

(57) ABSTRACT

A system and method for burning program information and compressed audio content into a recordable audio compact disc. The resulting compact disc can then be read and the information and audio content stored in non-volatile or other memory in an audio player tailored for use in the music-on-hold or in-store advertising markets. In various examples, the system and method includes an audio player with a CD player mechanism and audio production builder software. The data is processed in a digital format. In addition to the stored audio content, the compact disc includes program or play information.

### CROSS-REFERENCE TO RELATED APPLICATION

This patent application claims the benefit of priority, under 35 U.S.C. Section 119(e), to U.S. Provisional Patent Application Ser. No. 60/504,164, entitled AUDIO PLAYER WITH CD MECHANISM, filed on Sep. 18, 2003, inventor Anderson et al., and is herein incorporated by reference.

### TECHNICAL FIELD

This document relates generally to audio recording equipment, and in particular, but not by way of limitation, to structures and methods for generating re-programmable content for telephone on-hold and advertising purposes.

### BACKGROUND

Audio players that continually play and repeat stored audio productions are commonly used in music-on-hold and in in-store advertising applications. For marketing purposes, it is desirable that the player's audio productions be periodically changed to capture the attention of callers and store customers and to keep seasonal advertising and programming current.

Audio production facilities typically install and service the electronic equipment for the benefit of end users. The audio production facilities also typically provide updated audio content to the end users on a regular or as-needed basis.

Audio players differ in terms of how new audio productions are downloaded to the local, or on-site, unit. For example, some audio players are configured to download content through a telephone line or a computer network connection to a remote facility. Other audio players use various local download techniques and have built-in local load functionality including, for example, audio tape decks, compact disc (CD) decks, or sockets for receiving flash memory cards. Some local load units provide an input audio connector which is intended to be connected to another output audio source for recording or downloading.

Various limitations apply to all of the above download schemes. Remote download audio players typically require a more complex installation and method of download. In addition, remote download audio players must share telephone or network services within the building. Local download audio players are sometimes more complicated to program and operate. In addition, local download audio players sometimes include extra analog to digital conversions that degrades the sound quality.

Download time, which usually includes the play time of the audio file, can be inconveniently lengthy for local download audio players. The high cost of flash memory makes audio units with removable memory relatively expensive.

### SUMMARY

A replaceable medium with stored digital audio inserted into a player triggers an automatic download of the stored audio production into non-volatile memory.

A CD player mechanism is used to download digital audio from a CD with stored audio productions.

CD-ROM follows a specification sometimes referred to as the Yellow Book specification for computer data storage applications. The CD-ROM format includes a layer of error correction which is not used in the CD-Audio format which is sometimes referred to as the Red Book specification.

The present subject matter uses components and electronics tailored to CD-Audio format. The format stores data digitally and provides error detection and correction.

Typically, CD-Audio electronics include a CODEC so that analog audio is output directly from the CD Control chip set. The analog audio is fed directly to an audio amplifier and speaker when playing the audio CD. The present subject matter instead, intercepts the raw digital data, before reaching the CODEC, and stores this information into flash memory. The CODEC function built into the CD Control chip set is not used or is otherwise bypassed. In one example, the present subject matter uses a chip set provided by Rohm Electronics, however, other chip sets are available that provide suitable functionality.

The CD-Audio format, pursuant to the Red Book specification, stores audio in a stereo format at a 44.1 kHz sample rate using 16 bits of linear data per sample. This format results in a large amount of data for each audio file. Since this information is to be stored in flash or other memory, a small file size is desirable.

End users of on-hold audio systems and in-store advertising typically do not need the high sample rates and bandwidth associated with content recorded in CD-Audio format. In addition, users of on-hold audio systems and in-store advertising are typically satisfied with audio in a mono channel format. In one example, audio file size is reduced by using a mono audio production with lower sample rate stored on an audio CD. In one example, audio compression is provided to further compress the file size.

Standard CD-Audio disc burner software follows the Red Book specification. A standard CD-Audio disc burner will automatically attempt to convert an audio file into the specified audio format and burn the file onto the disc. Non-audio files can not normally be stored on a CD-Audio disc.

The present subject matter provides a method and structure for storing modified files, including audio and data content, onto a standard, recordable CD-Audio disc.

In one example, the present subject matter includes a method which causes a standard CD-Audio disc burner software to treat an information data file and one or more modified (and optionally, compressed) audio files as though they were compatible with 44.1 kHz stereo, 16 bit linear audio file content. If the CD-Audio disc burner determines that the file (which can include audio or data) appears to be an audio file of the proper format, then the file will not be changed. In this manner, a standard CD-Audio disc burner can be used to burn newly created and modified information files onto a recordable CD-Audio disc.

The present subject matter reads and downloads one or more audio files from a CD-Audio disc having burned custom information. In one example, the system also uses program information stored in a non-audio digital file on the CD-Audio disc to store additional program information or other data. The program information, in various examples, includes, for example, the number of stored audio tracks, the sample rate and audio compression schemes used to make the final audio file. The program information, in various examples, also includes information which distinguishes music files, voice-only files and stored audio prompts. In one example, program information includes play intervals for messages and other information for programming, playing and mixing of audio productions.

In one example, the present subject matter includes computer executable instructions for executing a method to create program information (data) and audio files that are burned into a CD-Audio disc for transferring and downloading that information into a player.

### BRIEF DESCRIPTION OF THE DRAWINGS

In the drawings, like numerals describe substantially similar components throughout the several views. Like numerals having different letter suffixes represent different instances of substantially similar components.

FIG. 1 illustrates a block diagram of the audio player.

FIG. 2 contains a flow chart of a method according to one example.

### DETAILED DESCRIPTION

In the following detailed description, reference is made to the accompanying drawings that form a part hereof, and in which is shown, by way of illustration, specific examples in which the present subject matter may be practiced. These examples are described in sufficient detail to enable those skilled in the art to practice the present subject matter, and it is to be understood that the examples may be combined, or that other examples may be utilized and that structural, logical and electrical changes may be made without departing from the scope of the present subject matter. The following detailed description is, therefore, not to be taken in a limiting sense, and the scope of the present subject matter is defined by the appended claims and their equivalents.

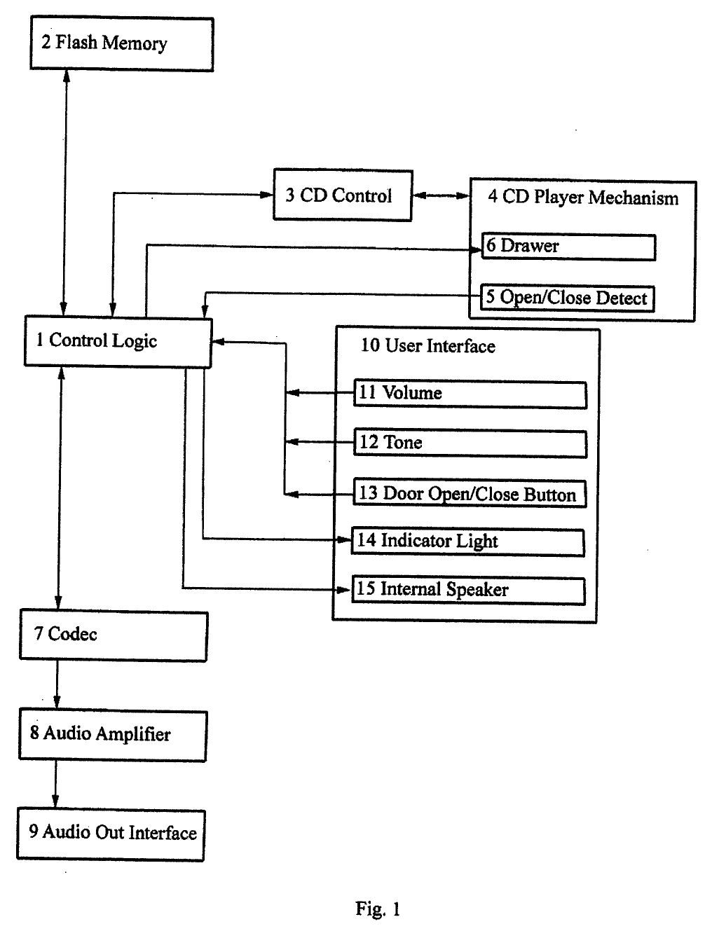

A block diagram of one example of the present subject matter is shown in FIG. 1. Interface 10 illustrates the user interface which includes volume control 11 and indicator light 14 for showing unit status. In one example, interface 10 includes door button 13 and internal speaker 15. Door button 13 includes a user operable switch to control opening and closing of a drawer for CD player mechanism 4. Internal speaker 15 provides an audio output for listening to audio prompts and to monitor the playing of the output audio production.

According to one method of operation, the present subject matter begins by downloading audio content from a CD-Audio disc having content burned with specially prepared custom files.

The present subject matter allows non-audio files containing player program information and audio files with other than 44.1 kHz, 16 bit linear, stereo to be burned into a standard CD-Audio disc.

To download the new audio content, the user opens the drawer 6 of CD player mechanism 4 by pressing the button 13. In one example, CD player mechanism 4 includes a CD-Audio burner or disc drive. Control logic 1 detects the button closure and opens drawer 6 by sending a command to CD control 3. CD control 3 includes a chip set that provides control and interface functions to operate an CD-Audio mechanism, an exemplary chip set of which is manufactured by Rohm. The user next inserts the custom CD-Audio disc into drawer 6 and presses the button 13. This action causes the drawer to be closed by control logic 1 and CD control 3. Control logic 1 detects that drawer 6 is closed and then detects, based on CD control 3, that a disc is present in drawer 6. The player is now ready to download the stored information from the disc.

Control logic 1 directs CD control 3 to begin spinning the disc and to begin reading data from the track number that contains stored data information rather than the stored audio files. The placement of track information (for example, the data information track) is predetermined by the designer. The track information includes information to program the player and/or to identify the remainder of the audio content on the disc. In one example, the end of this information contains a checksum. Control logic 1 calculates its own checksum on the read data and compares it with the checksum read from the disc. If the checksums agree, the data is valid and reading this track is complete. If the checksums disagree, control logic 1 continues to read additional copies of this data on the same track and calculates and compares the checksums. If repeated reads from various copies of the information on the data track fail, then control logic 1 aborts the download process and generates an error signal. In one example, the error signal is presented as a display by flashing indicator light 14 or by playing an appropriate audio message using internal speaker 15.

If control logic 1 detects that the disc located in the drawer is not of the correct type, then it indicates an invalid or defective disc via indicator light 14 or by playing an appropriate audio message on speaker 15. Speaker 15, in one example, includes an internal speaker.

Upon successful reading of the data information track, the player will have acquired all of the information to complete the downloading (storage into non-volatile or other memory) of audio tracks and program information and to begin playing audio pursuant to those instructions.

The player now proceeds to read and store audio files, or tracks, as instructed. This process proceeds in the same manner as described above for the data information file or track. The raw audio data is intercepted from CD control 3 and programmed into flash memory 2 or other on-board memory. This audio data is coming off of the disc in the desired storage format rather than the normal standard CD-Audio format of 44.1 kHz, 16 bit linear, stereo format.

After the audio tracks are stored pursuant to the instructions in the data information file, control logic 1 instructs CD control 3 to shut down CD player mechanism 4. The player can now indicate to the user successful completion of the download of the disc, by using indicator light 14 or by playing an appropriate audio prompt using speaker 15.

The player is now ready to begin playing audio pursuant to the stored instructions. To play audio, player control logic 1, retrieves the stored audio from flash memory 2 and decodes it if it has been compressed. Control logic 1 then sends the raw or decoded audio to CODEC 7 as required by the CODEC and for the given sample rate of the audio. CODEC 7 converts the digital audio data to an analog signal and sends the signal to audio amplifier 8. Audio amplifier 8 sends the amplified signal to audio out interface 9 on the player. The user connects their audio load to this interface.

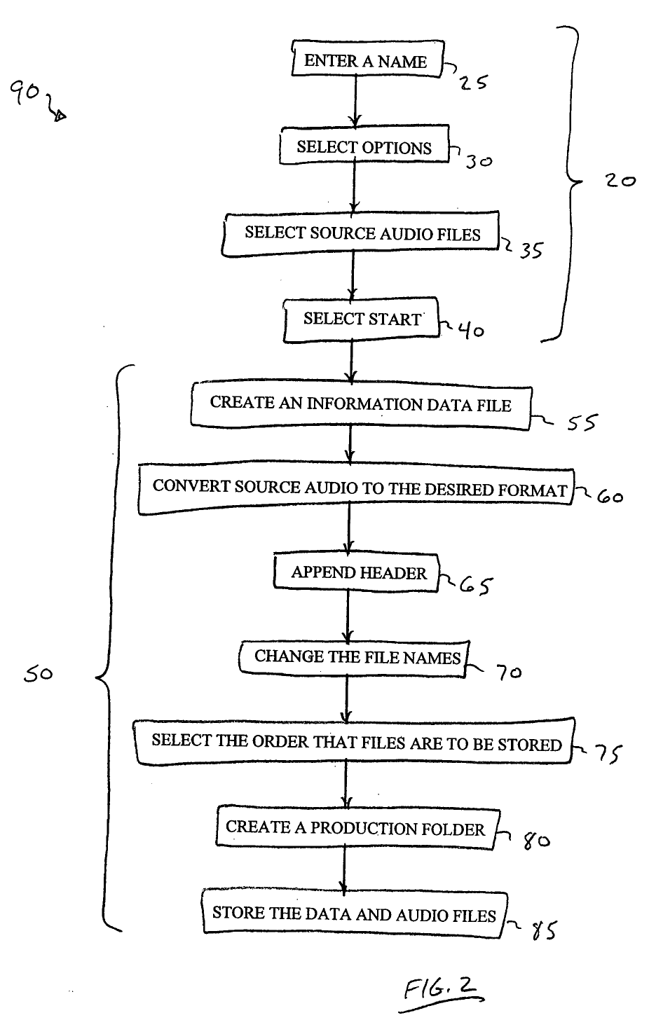

FIG. 2 illustrates method 90 according to one example of the present subject matter. In the figure, method 90 includes segment 20 directed to the user interface and segment 50 directed to building the production.

The custom files are created according to a method as described relative to FIG. 2. Method 90, according to one example, includes a method to modify data and audio files so that they can be burned into a standard recordable CD-Audio disc using a standard personal computer with a CD-Audio burner.

As part of segment 20, at 25, the user enters a name for the new production folder. In addition, at 30, the user selects options (if any) for the new production. Selectable options, in one example, include the sample rate, the number of audio files, the type of audio files (including, for example, music, voice message, audio prompts, etc.), an audio compression scheme and play intervals for messages. In one example, selectable options include other play, mixing or programming information for the unit.

Next, at 35, the user selects all source audio files to be stored on the disc followed by, as indicated at 40, pressing a start, or “build” button to instruct the program to create the production.

As for building the production, at 55, an information data file, or metadata file, is created based on the options selected earlier with the exception of the actual audio files. When making the information data file, multiple copies of the information, as well as a checksum of that information, is placed at the end of each copy. At 60, each source audio file is converted to the desired final audio format. This includes changing the sample rates and compressing the audio as desired. At 65, a header is appended. In one example, the header includes a RIFF/WAV header at the front of each data or raw audio file. The header indicates that the attached file includes a 16 bit linear, stereo audio file with a 44.1 kHz sample rate. At 70, the file names are changed for the newly created data and audio files. The replacement file names, in one example, start with the word “track” and end with numbers from 01 to 99. At 75, a decision is made as to the order that files are to be stored on the CD. In one example, the first file is named track01. The file name for each subsequent file is incremented by the number one. In one example, no duplicates or gaps in the numbers are allowed as the new names are assigned. At 80, a production folder is created with the name assigned by the user. At 85, the newly named data and audio files are placed in the production folder. The production folder contains the completed files for the production. The files (labeled track01 through track(end#)) are then ready to be burned into a disc.

### ADDITIONAL EXAMPLES

In addition to the examples described above, the present subject matter includes additional methods and systems.

In one example, audio is received in the form of a file or an audio signal from an audio storage device. The audio storage device can include a memory device or an audio source such as a magnetic tape drive or an audio compact disc player. The audio signal is encoded in a first storage format having a first data sampling rate. One method entails generating metadata based on the audio signal. In addition, an audio file is generated based on the audio signal. For example, the second storage format may include data sampled at a first sampling rate and the audio file includes data encoded with a second sampling rate (such as 8 kHz).compressed data having a sampling rate that is different than that provided by the audio storage device. The metadata and the audio file are stored on a storage medium using a second storage format which differs from that of the first storage format of the first audio file.

In one example, the audio file is generated by removing a header from the audio signal.

The data format for CD-Audio differs from that of CD-ROM typically found in a personal computer. While both entail a digital format, CD-Audio is simpler and uses a less rigorous error detection protocol. A player compatible with CD-Audio ordinarily will play stereo content having a sampling rate of 44.1 kHz, 16 bit linear WAV format and includes some track information. In contrast, content for CD-ROM typically uses Reed-Solomon encoding for error detection and also includes additional encoding layers. Accordingly, the hardware for CD-ROM is typically more complex and expensive than that for CD-Audio.

Ordinary telephone equipment will truncate the bandwidth of content to approximately 4 kHz. Accordingly, data from a CD-ROM compatible device will use additional programming to down-size the content and additional memory to store a larger file.

The present subject matter discloses a method and structure for achieving a smaller file size using a CD-Audio burner. For example, mono-channel (single-channel) audio content sampled at 8 kHz is adequate for telephone equipment.

In one example, the present subject matter spoofs the CD-Audio burner into treating the content as a 44.1 kHz file. In one example, the CD-Audio burner removes the header and stores the content.

In one example, the present subject matter includes a device having a CD-Audio burner. In one example, the device provides audio messages for the benefit of the dealers using the device. Exemplary messages include “do you want audio prompts or not?”; “door open—please insert disk and close the door”; “now digitizing” and “loading digital data into flash memory.”

One example of the present subject matter includes software configured to assist a dealer in the production of a disc. The software includes instructions to receive a dealer selected number corresponding to the number of audio productions to include on a disc. For example, the dealer can select 1 to 12 audio productions. Each audio production includes a file of audio that plays for approximately 6 minutes. Productions more numerous than 12 on a disc are also contemplated.

For the following description, assume that the dealer selects a single production. Next, the dealer specifies where the audio matter exists. For example, the audio may be stored in a memory location or a storage device. Next, the dealer selects a sampling rate. Exemplary sample rates include 6, 8, 12, 16 or 24 kHz. The processor executing the software then builds the file. The file includes mono channel audio and also includes a header that identifies the file as, for example, 44.1 kHz linear stereo, when in fact, the file includes, for example, mono audio at a sampling rate of 8 kHz.

The file is stored on a disc and includes a new folder. The new folder includes track 01 and track 02. Track01 includes the fake audio file with details as to contents that, in this example, includes no audio prompts and a sampling rate of 8 kHz. Track02 is the dealer created file. In one example, the file is represented by an icon on a desktop of a computer. The icon can be dragged to the CD-Audio burner using a mouse or other controller. The CD-Audio burner interprets the file as two ordinary audio files when in fact, one includes digital information and the other includes mono audio at an 8 kHz sample rate.

If played on a regular CD-Audio player, the first track will produce unintelligible sounds. If played on a device according to the present subject matter, the first track will indicate that the device should expect to find audio, with no message prompts and a single audio production having a sampling rate of 8 kHz. In addition, the present subject matter device will begin to play the audio of track02 and also store the data into flash memory for repeated playing.

The default configuration of one exemplary device provides that no audio prompts are played. In one example, audio prompts are played to indicate that the audio programs are being retrieved, that the device has completed loading of audio. Other prompts correspond to an indication that the drive door is in the open position and that an incorrect disc has been inserted (for example, the drive is unable to find track01). Other prompts announce that the production is being digitized. After the production has been stored in memory, the drive stops spinning the disc and the audio is played out of memory.

In one example, opening the door of the driver will trigger the initialization routine.

In one example, the device includes a microprocessor coupled to a chipset. The chipset interfaces to a disc drive.

In one example, tracks are burned onto a CD as follows:
track 01: track information regarding contents of the disc
track 02: audio files
track 03: audio prompts
track 04: audio prompts
track 05: audio prompts
track 06: audio production

The standard for CD-ROM (CD-ROM, ISO 9660, “High Sierra”) describes how digital data is recorded on compact disc media. The standard is sometimes referred to as “yellow book.”

The standard for CD-Audio is sometimes referred to as “red book.” A source sound file is encoded by converting to a digital format using a 44.1 kHz sampling rate with each sample having 16 bits pulse code modulation (PCM) for each of the two stereo channels. Other sampling rates are also contemplated, including 48 kHz, 88.2 kHz, 96 kHz and 192 kHz.

### Conclusion

The above description is intended to be illustrative, and not restrictive. Many other examples will be apparent to those of skill in the art upon reviewing the above description.

1. A system comprising:
a memory device configured to store audio content encoded in a first format, the first format having a first sampling rate;
a controller coupled to the memory device and configured to execute a set of instructions to generate an output file as a function of the audio content, the output file including an audio file and an audio header, the audio file encoded in a second format having a second sampling rate and the audio header encoded in a third format having a third sampling rate, wherein the third sampling rate is independent of the second sampling rate; and
a compact disc recorder coupled to the controller and configured to receive the output file and store the audio file on a compact disc.

2. The system of claim 1 wherein the first sampling rate matches the second sampling rate.

3. The system of claim 1 wherein the third sampling rate is approximately 44.1 kHz.

4. The system of claim 1 wherein the set of instructions are configured to generate an information file as a function of the audio content.

5. The system of claim 4 wherein the information file includes program information and an information header encoded in the third format.

6. The system of claim 5 wherein the information file includes a checksum and the set of instructions is configured to generate the checksum as a function of the program information.

7. The system of claim 1 further including an audio input interface coupled to the memory device.

8. The system of claim 1 wherein the compact disc recorder includes an audio compact disc drive.

9. The system of claim 1 wherein the compact disc drive is compatible with the Red Book standard.

10. A method comprising:
receiving audio content in a memory device, the audio content encoded in a first format, the first format having a first sampling rate;
generating an output file as a function of the audio content, the output file including an audio file and an audio header, the audio file encoded in a second format having a second sampling rate and the audio header encoded in a third format having a third sampling rate, wherein the third sampling rate is independent of the second sampling rate; and
receiving the output file at a compact disc recorder;
removing the audio header from the output file using the compact disc recorder; and
storing the audio file on an audio compact disc using the compact disc recorder.

11. The method of claim 10 wherein the second sampling rate is selected from 8 kHz, 12 kHz, 16 kHz and 24 kHz.

12. The method of claim 10 wherein the third sampling rate is approximately 44.1 kHz.

13. The method of claim 10 wherein generating the output file includes generating an information file as a function of the audio content, the information file including an information header and program information, wherein the information header is encoded in the third format and further including removing the information header using the compact disc recorder and storing the program information on the audio compact disc using the compact disc recorder.

14. The method of claim 13 wherein generating the output file includes generating a checksum as a function of the program information and wherein the information file includes the checksum.

15. The method of claim 13 wherein generating the information file includes generating a data string corresponding to a number of audio programs, a number of audio prompts, an audio compression scheme and a sample rate for the audio content, a play list indicating an order for the audio programs and a pause time interval.

16. The method of claim 13 wherein storing the program information includes storing multiple copies of the information file.

17. The method of claim 10 wherein receiving the audio content includes receiving multiple channel audio and wherein storing includes storing single channel audio.

18. The method of claim 10 further including storing at least one user selected audio message using the compact disc recorder.

19. A system comprising:
an audio compact disc drive configured to read digital audio data and an information file from an audio compact disc, the information file including a sample rate for the digital audio data;
a memory coupled to the compact disc drive and configured to store the digital audio data and information file;
a controller coupled to the memory and configured to generate an analog signal as a function of the digital audio data and as a function of the information file; and
an output interface coupled to the controller and configured to provide an output signal as a function of the analog signal.

20. The system of claim 19 wherein the controller is configured to generate a checksum as a function of the information file.

21. The system of claim 20 wherein the controller is configured to compare the checksum with a value encoded in the information file.

22. The system of claim 19 further including a user operable control coupled to the controller and configured to provide a selection signal and wherein the output signal is a function of the selection signal.

23. The system of claim 19 wherein the digital audio data includes multiple channel audio and wherein the output signal includes single channel audio.
